(19) United States
(12) Patent Application Publication
(10) Pub. No.: US 2013/0143025 A1
(43) Pub. Date: Jun. 6, 2013

(54) THERMOPLASTIC RESIN IMPREGNATED TAPE

(71) Applicants: Makoto KIBAYASHI, Decatur, AL (US); Satoshi Seike, Decatur, AL (US); Lawrence A. Pranger, Decatur, AL (US); Anand Valliyur Rau, Decatur, AL (US)

(72) Inventors: Makoto KIBAYASHI, Decatur, AL (US); Satoshi Seike, Decatur, AL (US); Lawrence A. Pranger, Decatur, AL (US); Anand Valliyur Rau, Decatur, AL (US)

(21) Appl. No.: 13/312,170

(22) Filed: Dec. 6, 2011

(51) Int. Cl. B32B 5/02

(52) U.S. Cl. 428/221

(57) ABSTRACT

A thermoplastic resin impregnated tape is made of a carbon fiber, which is coated with a sizing at an amount X between 0.05 and 0.30 weight %. The sizing is formed of a heat resistant polymer or a precursor of the heat resistant polymer. The amount X of the sizing is expressed with a following formula:

$$X = \frac{{W}_{0} - {W}_{1}}{{W}_{0}} \times 100$$

where W₀ is the weight of the carbon fiber with the sizing, and W₁ is the weight of the carbon fiber without the sizing.

### BACKGROUND OF THE INVENTION AND RELATED ART STATEMENT

The present invention relates to a thermoplastic resin impregnated tape having a carbon fiber with a sizing capable of achieving good mechanical property and resistance against thermal degradation.

Thermoplastic resin impregnated tapes are used for Carbon fiber reinforced thermoplastics (CFRTP), which have good mechanical properties such as high specific strength, high specific modulus and high impact strength, and an advantage such as quick molding. In recent years, research and development efforts in this area have been flourishing.

In general, polymer matrix composite materials tend to show reduced strength and modulus under high temperature conditions. Therefore, heat resistant matrix resins are necessary in order to maintain desired mechanical properties under high temperature conditions. Such heat resistant matrix resins include a thermoplastic polyimide resin, a polyamideimide resin, a polyetherimide resin, a polysulfone resin, a polyethersulfone resin, a polyetheretherketone resin, a polyetherketoneketone resin, polyamide66 and a polyphenylenesulfide resin.

CFRP with heat resistant matrix resins are molded under high temperature conditions, so the sizing must withstand thermal degradation. If the sizing undergoes thermal degradation, voids and some other problems occur inside a composite that result in reduced composite mechanical properties. Accordingly, a heat resistant sizing is an essential part of CFRP for good handleability, high interfacial strength, controlling fuzz development, etc.

A carbon fiber coated with a heat resistant sizing and a thermoplastic resin impregnated tape having the fiber have been developed and tried in the past. For instance, U.S. Pat. No. 4,394,467 and U.S. Pat. No. 5,401,779 have disclosed a polyamic acid oligomer as an intermediate agent generated from a reaction of an aromatic diamine, an aromatic dianhydride, and an aromatic tetracarboxylic acid diester. When the intermediate agent is applied to a carbon fiber at an amount of 0.3 to 5 weight % (or more desirably 0.5 to 1.3 weight %), it is possible to produce a polyimide sizing. However, the sizing amount of 0.3 to 5 weight % does not seem efficient for good spreadability of carbon fibers related to resin impregnation, for fabrication of a tape with low void content and best mechanical properties.

In U.S. Pat. No. 5,403,666, a heat resistant thermoplastic prepreg using carbon fiber, and a composite made of the prepreg has been disclosed. However, the sizing amount, that is essential to obtain the optimal spreadability of a carbon fiber and the low void content in the composite made of the tape, has not been disclosed.

In view of the problems described above, the object of the present invention is to provide a thermoplastic resin impregnated tape having a carbon fiber with a thermally stable sizing that enables enhanced adhesion to the thermoplastic matrix, and a lower propensity for generation of voids during processing owing to the inherent thermal stability as compared with less stable sizings.

Further objects and advantages of the invention will be apparent from the following description of the invention.

### SUMMARY OF THE INVENTION

In order to attain the objects described above, according to the present invention, a thermoplastic resin impregnated tape is made of a carbon fiber coated with a sizing at an amount X between 0.05 and 0.30 weight %. The sizing is formed of a heat resistant polymer or a precursor of the heat resistant polymer. The amount X of the sizing is expressed as percentage by the following formula:

$$X = \frac{{W}_{0} - {W}_{1}}{{W}_{0}} \times 100$$

where W₀ is the weight of the carbon fiber with the sizing, and W₁ is the weight of the carbon fiber without the sizing.

### BRIEF DESCRIPTION OF THE DRAWINGS

FIG. 1 is a graph showing a relationship between drape value and sizing amount on fiber (ULTEM type polyetherimide, T700SC-12K, ULTEM is a registered trademark of Saudi Basic Industries Corporation);

FIG. 2 is a graph showing a relationship between rubbing fuzz and sizing amount on fiber (ULTEM type polyetherimide, T700SC-12K);

FIG. 3 is a graph showing a TGA measurement result of T700S type fiber coated with ULTEM type polyetherimide;

FIG. 4 is a graph showing a TGA measurement result of ULTEM type polyetherimide;

FIG. 5 is a schematic view showing a measurement procedure of drape value;

FIG. 6 is a schematic view showing a measurement instrument of rubbing fuzz; and

FIG. 7 is geometry of a dumbbell shaped specimen for Single Fiber Fragmentation Test.

Table 1 shows a relationship between drape value and sizing amount (ULTEM type polyetherimide, T700SC-12K);

Table 2 shows a relationship between rubbing fuzz and sizing amount (ULTEM type polyetherimide, T700SC-12K);

Table 3 shows a comparison of polyphenylenesulfide composite properties;

Table 4 shows a comparison of polyamide66 composite properties; and

Table 5 shows adhesion strength between a T700S type fiber and polyetherimide resin.

### DETAILED DESCRIPTION OF PREFERRED EMBODIMENTS

Embodiments of the present invention will be explained with reference to the accompanying drawings.

In the embodiment, the width of a thermoplastic resin impregnated tape is desirably more than 10 mm for high productivity of composite manufacturing and the thickness is desirably 0.1 to 1.0 mm.

The ideal volume fraction of carbon fiber in a tape is 20 to 75 volume %. 30 to 70 volume % is more ideal. The volume fraction should be greater than 20 volume % to achieve good mechanical properties of a composite made of thermoplastic resin impregnated tapes. On the other hand the volume fraction should be less than 75 volume % to avoid high void content of a thermoplastic resin impregnated tape, which could result in unpredictable reduced mechanical property of a composite.

The retained compression strength of the composite after wet aging is desirably greater than 80%. Greater than 85% is more desirable. Greater than 90% is even more desirable. (The wet aging conditions are described later)

A thermoplastic resin impregnated tape is fabricated according to prior arts such as an impregnation from a solution, emulsion, molten resin particles or sheet, and melt pultrusion.

A commercially available carbon fiber is used (including graphite fiber). Specifically, a pitch type carbon fiber, a rayon type carbon fiber, or a PAN (polyacrylonitrile) type carbon fiber is used. Among these carbon fibers, the PAN type carbon fibers that have high tensile strength are the most desirable for the invention.

Among the carbon fibers, there are a twisted carbon fiber, an untwisted carbon fiber and a never twisted carbon fiber. The carbon fibers have preferably a yield of 0.06 to 4.0 g/m and a filament number of 1,000 to 48,000. In order to have high tensile strength and high tensile modulus in addition to low fuzz generation during the carbon fiber production, the single filament diameter should be within 3 μm to 8 μm, more ideally, 4 μm to 7 μm.

Strand strength is desirably 3.0 GPa or above. 4.5 GPa or above is more desirable. 5.5 GPa or above is even more desirable. Tensile modulus is desirably 200 GPa or above.

220 GPa or above is more desirable. 240 GPa or above is even more desirable. If the strand strength and modulus of the carbon fiber are below 3.0 GPa and 200 GPa, respectively, it is difficult to obtain the desirable mechanical property when the carbon fiber is made into composite materials.

The desirable sizing amount on carbon fiber is between 0.05 and 0.30 weight %. Between 0.05 and 0.25 weight % is more desirable. Between 0.05 and 0.20 weight % is even more desirable. If the sizing amount is less than 0.05 weight %, when carbon fiber tow is spread under tension, fuzz generation becomes an issue and may prevent a smooth fabrication process of a tape. If on the other hand, the sizing amount is above 0.30 weight %, the carbon fiber is almost completely coated by the heat resistant polymer, resulting in poor density (low), and poor spreadability. When this occurs, even resins with relatively low viscosity have undergone reduced impregnation; thereby leading to low mechanical properties. In addition from an environmental standpoint, if the sizing amount is above 0.30 weight %, the possibility that harmful volatiles are generated becomes higher during the sizing application process.

In order for the thermoplastic resin impregnated tape to have effective resin impregnation, a carbon fiber should have good drapeability. A drapeability of a carbon fiber (measured by the procedures described below) can be defined as drape value having less than 15 cm, 12 cm or less is better, 10 cm or less is even more desirable, 8 cm or less is most desirable.

The desirable relation B/A is greater than 1.05, and more desirable relation B/A is greater than 1.1, where A is the Interfacial Shear Strength (IFSS) of unsized fiber and B is IFSS of sized fiber in the present invention whose surface treatment must be same as the unsized fiber. IFSS can be measured by the Single Fiber Fragmentation Test (SFFT), and unsized fiber could be de-sized fiber. A SFFT procedure and a de-sizing method will be described later.

Sizing application process as a part of carbon fiber manufacturing is preferred to post application or “oversizing” of carbon fiber for use in thermoplastic tape manufacturing to avoid much fuzz generation and high contamination.

As for the matrix resin, most heat resistant resins could be used. The invention is not limited to any particular heat resistant thermoplastic resins, and a thermoplastic polyimide resin, a polyamideimide resin, a polyetherimide resin, a polysulfone resin, a polyethersulfone resin, a polyetheretherketone resin, a polyetherketoneketone resin, and a polyphenylenesulfide resin may be used.

A heat resistant polymer is a desirable sizing agent to be used for sizing the carbon fiber. The sizing agents include a phenol resin, a urea resin, a melamine resin, a polysulfone resin, a polyethersulfone resin, a polyetheretherketone resin, a polyetherketoneketone resin, a polyphenylenesulfide resin, a polyimide resin, a polyamideimide resin, a polyetherimide resin, and others. For some types of sizings, when the heat resistant polymer or polymer precursor is reacted chemically in order to obtain heat resistant polymer sizing on a carbon fiber, water could be generated by a condensation or addition reaction. For these sizings, it is desirable to complete the reaction in the process of the sizing application. Otherwise, voids in a composite could become a problem due to evolution of reaction product. An example of a heat resistant polymer is as described below.

A polyimide is made by heat reaction or chemical reaction of polyamic acid. During the imidization process, water is generated; therefore, it is important to complete imidization before composite fabrication. A water generation ratio W based on a carbon fiber during a composite fabrication process is preferably 0.05 weight % or less. 0.03 weight % or less is desirable. Ideally, 0.01 weight % or less is optimal. The water generation ratio W can be defined by the following equation:

W(weight %)=B/A×100

where the weight A of a sized fiber is measured after holding 2 hours at 110 degrees Celsius and the weight difference B between 130 degrees Celsius and 415 degrees Celsius of a sized fiber is measured under air atmosphere with TGA (holding 110 degrees Celsius for 2 hours, then heating up to 450 degrees Celsius at 10 degrees Celsius/min).

An imidization ratio X of 80% or higher is acceptable, and 90% or higher is desirable. Ideally, 95% or higher is optimal. The imidization ratio X is defined by the following equation:

X(%)=(1−D/C)×100

where the weight loss ratio C of a polyamic acid without being imidized and the weight loss ratio D of a polyimide are measured between 130 degrees Celsius and 415 degrees Celsius under air atmosphere with TGA (holding 110 degrees Celsius for 2 hours, then heating up to 450 degrees Celsius at 10 degrees Celsius minute).

The heat resistant polymer is preferably used in a form of an organic solvent solution, a water solution, a water dispersion or a water emulsion of the polymer itself or a polymer precursor. A polyamic acid which is the precursor to a polyimide is enabled to be water soluble by neutralization with alkali. It is preferred for the alkali to be water soluble. Chemicals such as ammonia, a monoalkyl amine, a dialkyl amine, a trialkyl amine, and tetraalkylammonium hydroxide could be used.

Organic solvents such as DMF (dimethylformamide), DMAc (dimethylacetamide), DMSO (dimethylsulfoxide), NMP (N-methylpyrrolidone), THF (tetrahydrofuran), etc. could be used. Naturally, low boiling point and safe solvents should be selected. It is desirable that the sizing agent is dried and sometimes reacted chemically in low oxygen concentration air or inert atmosphere such as nitrogen to avoid forming explosive mixed gas.

### <Fabrication Process of a Thermoplastic Resin Impregnated Tape>

A conventional process described in U.S. Pat. Nos. 3,873,389; 3,993,726; 4,532,169 and 4,588,538 can be used. One example is shown as follows.

Individual fiber strands are pulled from the bobbins directed into a gas jet spreader. The gas jet spreader consists of a gas box into which compressed air or another gas is fed. The preferred pressure of gas flow into the gas jet spreader is approximately 100 psi or less.

As the fiber moves through a crosshead die and reaches the point where the polymer exits, the polymer is forced into contact with the fibers actually surrounding each individual fiber. The resulting resin impregnated tape exits from the die.

The preferred types of extruders used for extruding the thermoplastic polymer are the so-called screw extruders (preferably twin screw). Polymeric flake or chip is added to the extruder, melted and then forced out from the extruder and in through the entry barrel of the crosshead die. The temperature at which the extruder operates is dependent on the melting point of the thermoplastic polymer. In general, it is preferred that the extruder be operated approximately 30 to 55 degrees Celsius higher than the melting point of the polymer. For example, the operation temperature of polyphenylenesulfide resin is about 380 degrees Celsius and polyamide66 is about 320 degrees Celsius. The pressure within the crosshead die is no more than about 2 or 3 atmospheres.

After impregnation, the resulting tape is pulled from the exit die by the drive rolls, and immediately cooled in a gas cooler.

### <Glass Transition Temperature>

The sizing has a glass transition temperature above 100 degrees Celsius. Above 150 degrees Celsius is better. Even more preferably the glass transition temperature shall be above 200 degrees Celsius.

A glass transition temperature is measured according to ASTM E1640 Standard Test Method for “Assignment of the Glass Transition Temperature by Dynamic Mechanical Analysis” using a Differential Scanning calorimetry (DSC).

### <Thermal Degradation Onset Temperature>

A thermal degradation onset temperature of a sized fiber is preferably above 300 degrees Celsius. 370 degrees Celsius or higher is more desirable, 450 degrees Celsius or higher is most desirable. When a thermal degradation onset temperature is measured, first, a sample with a weight of about 5 mg is dried in an oven at 110 degrees Celsius for 2 hours, and cooled down to room temperature. Then it is weighed and placed on a thermogravimetric analyzer (TGA) under air atmosphere. Then, the sample is analyzed under an air flow of 60 ml/minute at a heating ratio of 10 degrees Celsius/minute. A weight change is measured between room temperature and 600 degrees Celsius. The degradation onset temperature of a sized fiber is defined as a temperature at which an onset of a major weight loss occurs. From the TGA experimental data, the sample weight, expressed as a percentage of the initial weight, is plotted as a function of the temperature (abscissa). By drawing tangents on a curve, the thermal degradation onset temperature is defined as an intersection point where tangent at a steepest weight loss crosses a tangent at minimum gradient weight loss adjacent to the steepest weight loss on a lower temperature side.

The definition of a thermal degradation onset temperature applies to the state of a carbon fiber after the chemical reaction but before a resin impregnation. The heat resistant property is imparted to the sized fiber by a chemical reaction affected before fiber is impregnated with resin.

If it is difficult to measure a thermal degradation onset temperature of a sized fiber, the sizing can be used in place of a sized fiber.

### <30% Weight Reduction Temperature>

30% weight reduction temperature of a sizing is preferably higher than 350 degrees Celsius. 420 degrees Celsius or higher is more desirable. 500 degrees Celsius or higher is most desirable. When a 30% weight reduction temperature is measured, first, a sample with a weight of about 5 mg is dried in an oven at 110 degrees Celsius for 2 hours, and cooled down to room temperature. Then it is weighed and placed on a thermogravimetric analyzer (TGA) under air atmosphere. Then, the sample is analyzed under an air flow of 60 ml/minute at a heating ratio of 10 degrees Celsius/minute. A weight change is measured between room temperature and 600 degrees Celsius. From the TGA experimental data, the sample weight, expressed as a percentage of the initial weight, is plotted as a function of the temperature (abscissa). The 30% weight reduction temperature of the sizing is defined as a temperature at which the weight of the sizing reduces by 30% with reference to the weight of the said sizing at 130 degrees Celsius.

### <Sizing Agent Application Method>

A sizing agent application method includes a roller sizing method, a submerged roller sizing method and/or a spray sizing method. The submerged roller sizing method is desirable because it is possible to apply a sizing agent very evenly even to large filament count tow fibers. Sufficiently spread carbon fibers are submerged in the sizing agent. In this process, a number of factors become important such as a sizing agent concentration, temperature, fiber tension, etc. for the carbon fiber to attain the optimal sizing amount for the ultimate objective to be realized. Often, ultrasonic agitation is applied to vibrate carbon fiber during the sizing process for better end result.

In order to achieve a sizing amount 0.05 to 0.30 weight % on the carbon fiber, the sizing concentration in the bath is preferably 0.05 to 2.0 weight %, more preferably 0.1 to 1.0 weight %.

<Compressive Strength after Wet Aging>

Test samples made of polyamide66 resin impregnated tapes are placed in deionised water at 80 degrees Celsius for 8 days. After that, in accordance with EN2850 Standard Test Method for “Compression Test Parallel to the Fibre Direction on Carbon Fibre Reinforced Plastics”, the compression tests are conducted.

### <Drying Treatment>

After the sizing application process, the carbon fiber goes through the drying treatment process in which water and/or organic solvent will be dried, which are solvent or dispersion media. Normally an air dryer is used and the dryer is run for 6 seconds to 15 minutes. The dry temperature should be set at 200 degrees Celsius to 450 degrees Celsius, 240 degrees Celsius to 410 degrees Celsius would be more ideal, 260 degrees Celsius to 370 degrees Celsius would be even more ideal, and 280 degrees Celsius to 330 degrees Celsius would be most desirable.

In case of thermoplastic dispersion, it is desirable that it should be dried at over the formed or softened temperature. This could also serve a purpose of reacting to the desired polymer characteristics. For this invention, the heat treatment will possibly be used with a higher temperature than the temperature used for the drying treatment. The atmosphere to be used for the drying treatment should be air; however, when an organic solvent is used in the process, an inert atmosphere involving elements such as nitrogen could be used.

### <Winding Process>

The carbon fiber tow, then, is wound onto a bobbin. The carbon fiber produced as described above is evenly sized. This helps make desired carbon fiber reinforced composites materials when mixed with the resin.

### EXAMPLES

Examples of a thermoplastic resin impregnated tape are explained next. The following methods are used for evaluating properties of the tape and a carbon fiber.

### <Sizing Amount>

Sizing amount in this invention is defined as the higher of the values obtained by the following two methods outlined below, and is considered to represent a reasonably true estimate of the actual amount of sizing on the fiber.

If a carbon fiber in itself cannot be obtained, a carbon fiber in a tape can be used by removing the matrix resin with a solvent and so on. After the fiber is rinsed, the sizing amount can be measured according to the following two methods.

### (Alkaline Method)

Sizing amount (weight %) is measured by the following method.

(1) About 5 g carbon fiber is taken.
(2) The sample is placed in an oven at 110 degrees Celsius for 1 hour.
(3) It is then placed in a desiccator to be cooled down to the ambient temperature (room temperature).
(4) A weight W₀ is weighed.
(5) For removing the sizing by alkaline degradation, it is put in 5% KOH solution at 80 degrees Celsius for 4 hours.
(6) The de-sized sample is rinsed with enough water and placed in an oven for 1 hour at 110 degrees Celsius.
(7) It is placed in a desiccator to be cooled down to ambient temperature (room temperature).
(8) A weight W₁ is weighed.

The sizing amount (weight %) is calculated by the following formula.

Sizing amount(weight %)=(W₀−W₁)/(W₀)×100

### (Burn Off Method)

The sizing amount (weight %) is measured by the following method.

(1) About 2 g carbon fiber is taken.
(2) The sample is placed in an oven at 110 degrees Celsius for 1 hour.
(3) It is then placed in a desiccator to be cooled down to ambient temperature (room temperature).
(4) A weight W₀ is weighed.
(5) For removing the sizing, it is placed in a furnace of nitrogen atmosphere at 450 degrees Celsius for 20 minutes, where the oxygen concentration is less than 7 weight %.
(6) The de-sized sample is placed in a nitrogen purged container for 1 hour.
(7) A weight W₁ is weighed.
The sizing amount (weight %) is calculated by the following formula.

Sizing amount(weight %)=(W₀−W₁)/(W₀)×100

### <Drape Value>

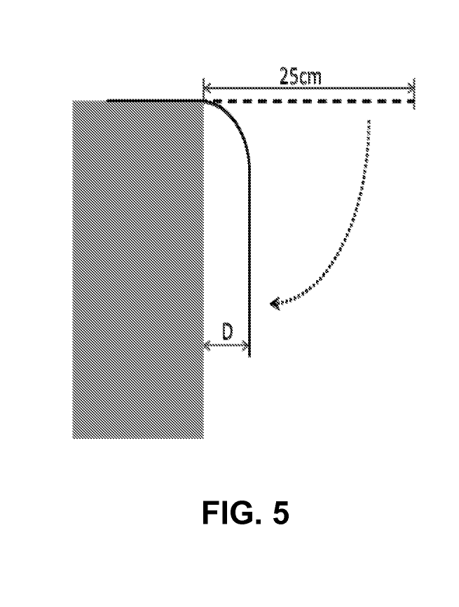

A carbon fiber tow is cut from the bobbin to a length of about 50 cm without applying any tension. A weight is attached on one end of the specimen after removing any twists and/or bends. The weight is 30 g for 12,000 filaments and 60 g for 24,000 filaments, so that 1 g tension is applied per 400 filaments. The specimen is then hung in a vertical position for 30 minutes with the weighted end hanging freely. After the weight is released from the specimen, the specimen is placed on a rectangular table such that a portion of the specimen is extended by 25 cm from an edge of the table having 90 degrees angle as shown in FIG. 5. The specimen on the table is fixed with an adhesive tape without breaking so that the portion hangs down from the edge of the table. A distance D (refer to FIG. 5) between a tip of the specimen and a side of the table is defined as the drape value.

### <Rubbing Fuzz Count>

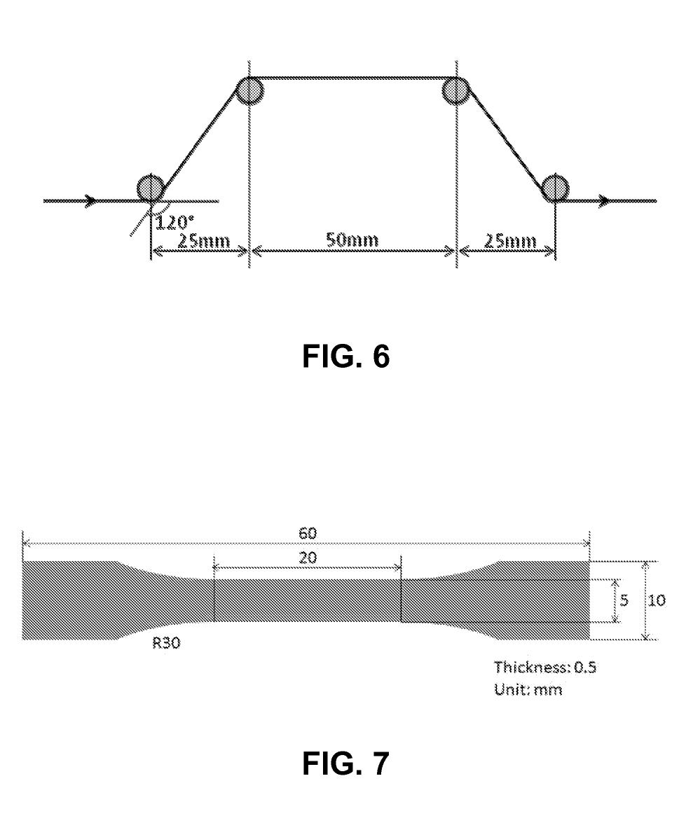

As shown in FIG. 6, a carbon fiber tow is slid against four pins with a diameter of 10 mm (material: chromium steel, surface roughness: 1 to 1.5 μm RMS) at a speed of 3 meter/minute in order to generate fuzz. The initial tension to a carbon fiber is 500 g for the 12,000 filament strand and 650 g for 24,000 filament strand. The carbon fiber is slid against the pins by an angle of 120 degrees. The four pins are placed (horizontal distance) 25 mm, 50 mm and 25 mm apart (refer to FIG. 6). After the carbon fiber passes through the pins, fuzz blocks light incident on a photo electric tube from above, so that a fuzz counter counts the fuzz count.

### <Single Fiber Fragmentation Test (SFFT)>

Specimens are prepared with the following procedure.

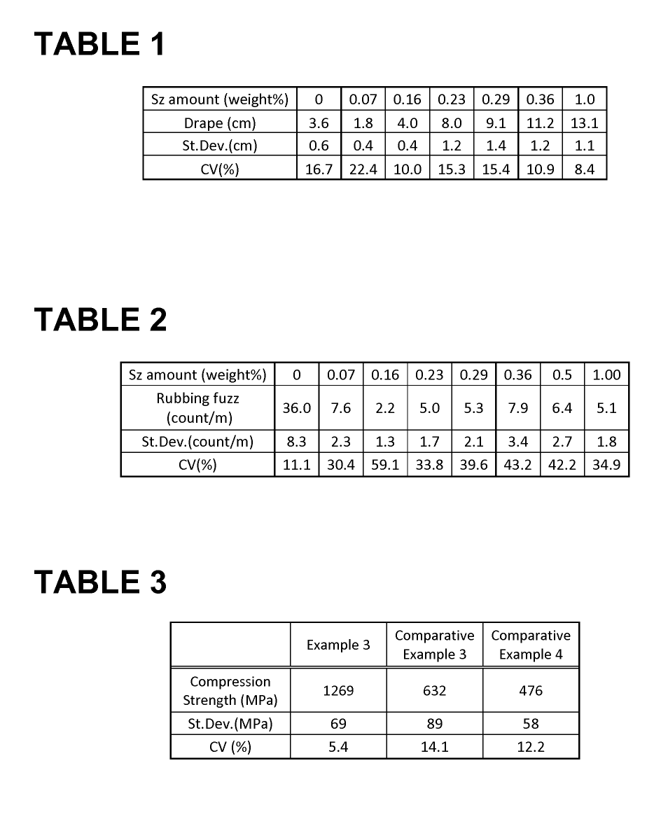

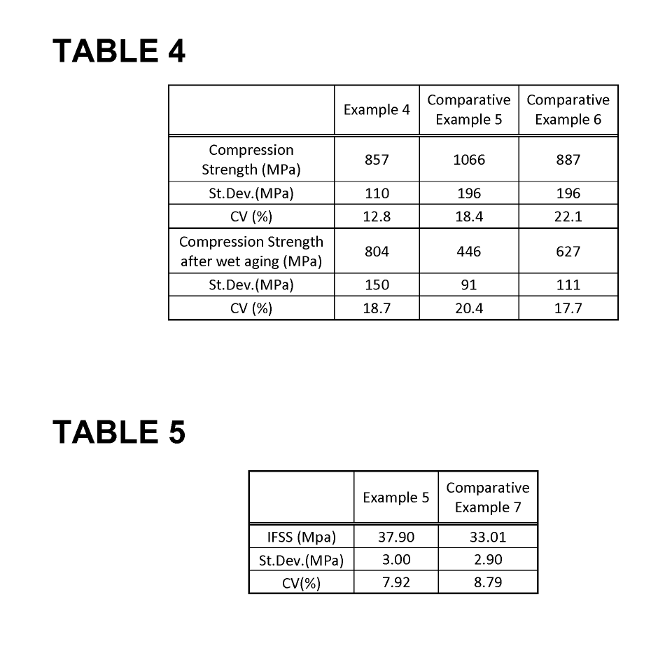

(1) Two aluminum plates (length: 250× width: 250× thickness: 6 (mm)), a KAPTON film (thickness: 0.1 (mm)), a KAPTON tape, a mold release agent, an ULTEM type polyetherimide resin sheet (thickness 0.26 (mm)), which must be dried in a vacuum oven at 110 degrees Celsius for at least 1 day, and carbon fiber strand are prepared.
(2) The KAPTON film (thickness: 0.1 (mm)) coated with a mold release agent is set on an aluminum plate.
(3) The ULTEM type polyetherimide resin sheet (length: 90× width: 150× thickness: 0.26 (mm)), whose grease on the surface is removed with acetone, is set on the KAPTON film.
(4) A single filament is picked up from the carbon fiber strand and set on the ULTEM type polyetherimide resin sheet.
(5) The filament is fixed at the both sides with a KAPTON tape to be kept straight.
(6) The filament (filaments) is overlapped with another ULTEM type polyetherimide resin sheet (length: 90× width: 150× thickness: 0.26 (mm)), and KAPTON film (thickness: 0.1 (mm)) coated with a mold release agent is overlapped on it.
(7) Spacers (thickness: 0.7 (mm)) are set between two aluminum plates.
(8) The aluminum plates including a sample are set on the pressing machine at 290 degrees Celsius.
(9) They are heated for 10 minutes contacting with the pressing machine at 0.1 MPa.
(10) They are pressed at 1 MPa and cooled at a speed of 15 degrees Celsius/minute being pressed at 1 MPa.
(11) They are taken out of the pressing machine when the temperature is below 180 degrees Celsius.
(12) A dumbbell shaped specimen, where a single filament is embedded in the center along the loading direction, has the center length 20 mm, the center width 5 mm and the thickness 0.5 mm as shown in FIG. 7.

SFFT is performed at an instantaneous strain rate of approximately 4%/minute counting the fragmented fiber number in the center 20 mm of the specimen at every 0.64% strain with a polarized microscope until the saturation of fragmented fiber number. The preferable number of specimens is more than 2 and Interfacial Shear Strength (IFSS) is obtained from the average length of the fragmented fibers at the saturation point of fragmented fiber number. IFSS can be calculated from the equation below, where σ_{f} is the strand strength, d is the fiber diameter, L_{c} is the critical length (=4*L_{b}/3) and L_{b} is the average length of fragmented fibers.

$$IFSS = \frac{{σ}_{f} \cdot d}{2 {L}_{e}}$$

### <De-Sizing Process>

De-sized fiber may be used for SFFT in place of unsized fiber. De-sizing process is as follows.

(1) Sized fiber is placed in a furnace of nitrogen atmosphere at 500 degrees Celsius, where the oxygen concentration is less than 7 weight %.
(2) The fiber is kept in the furnace for 20 minutes.
(3) The de-sized fiber is cooled down to room temperature in nitrogen atmosphere for 1 hour.

### Example 1

### Comparative Example 1

### (Thermoplastic Resin Impregnated Tape)

Polyphenylenesulfide resin impregnated tapes were fabricated by impregnating carbon fiber strands with polyphenylenesulfide resin at about 380 degrees Celsius according to a prior art, which included processes such as spreading strands, pre-heating, resin impregnation in a die, calendaring cooling and winding. The tape width was about 250 mm, the thickness was about 0.3 mm and the length was more than 1 meter. A tape made of carbon fiber with 0.16 weight % sizing could be fabricated successfully (Example 1), but another tape made of carbon fiber with 1.0 weight % sizing could not be done because of the high amount of sizing (Comparative Example 1).

### (Carbon Fiber)

A carbon fiber used for the above tapes was fabricated as follows. Unsized 12K high tensile strength, standard modulus carbon fiber “Torayca” T700SC (Registered trademark by Toray Industries—strand strength 4.9 GPa, strand modulus 230 GPa) was continuously submerged in a sizing bath containing polyamic acid dimethylaminoethanol salt of 0.4 and 2.5 weight %. The polyamic acid is formed from the monomers 2,2′-Bis(4-(3,4-dicarboxyphenol)phenyl)propane dianhydride and meta-phenylene diamine. After the submerging process, it was dried at 300 degrees Celsius for 1 minute in order to have ULTEM type polyetherimide sizing. The sizing amount was about 0.16 and 1.0 weight % according to an alkaline method, respectively.

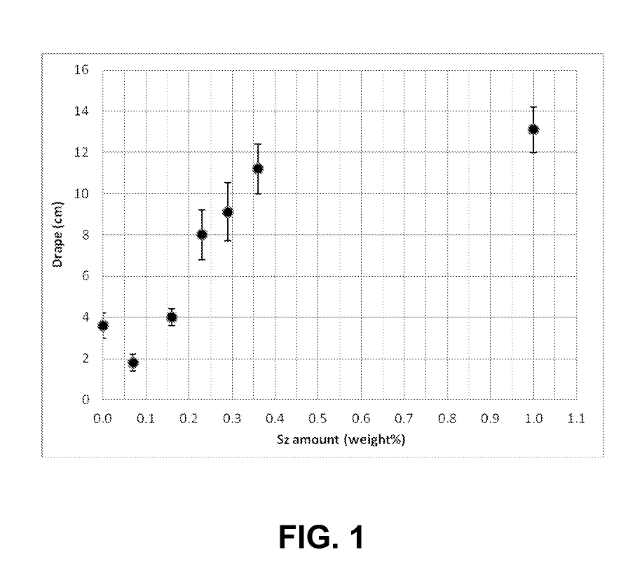

Next, carbon fibers were sized by 0.07 to 1.0 weight % according to the same procedure as above other than the sizing amount. The drape value is indicated in both Table 1 and FIG. 1. The error bar in the figure indicates the standard deviation. The samples with less than 0.30 weight % sizing have superior drapeability compared to those with more than 0.30 weight %, verifying a carbon fiber with less than 0.30 weight % has good drapeability related to spreadablity and resin impregnation.

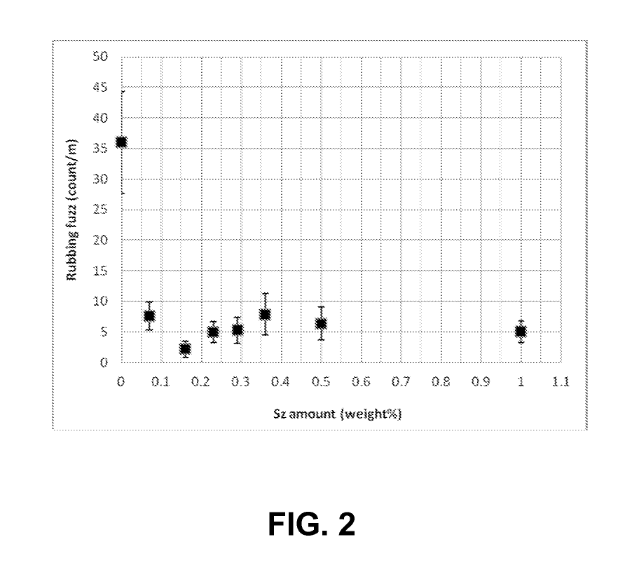

Rubbing fuzz of carbon fibers sized by 0.07 to 1.0 weight % is shown in Table 2 and FIG. 2. The error bar in the figure indicates the standard deviation. The fuzz count of every sized fiber is almost equal. The carbon fiber without a sizing agent generated much fuzz indicating the effectiveness of sizing in preventing fuzz occurrence.

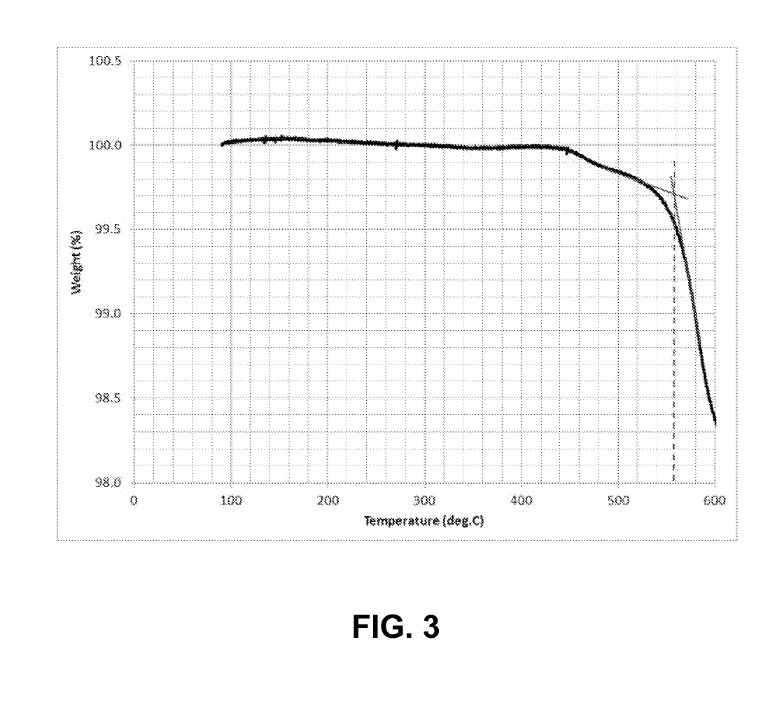

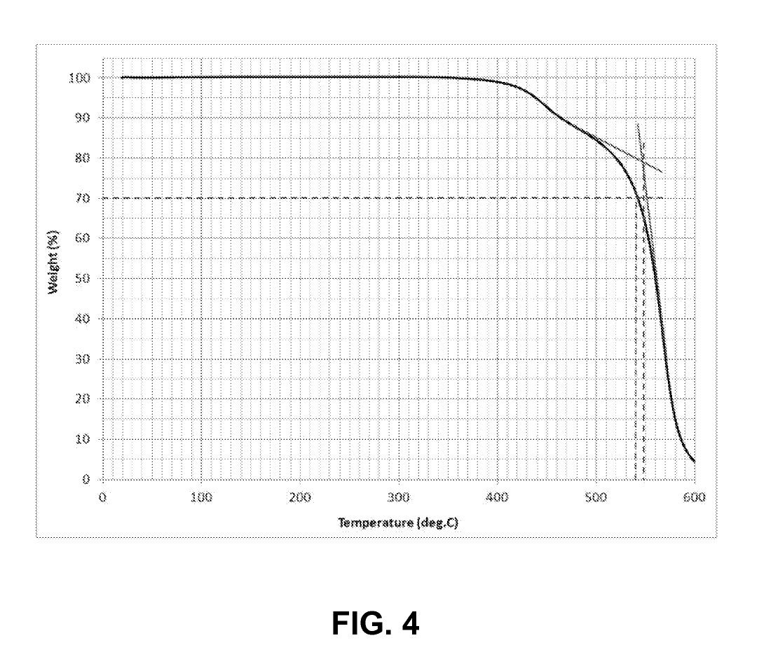

Thermogravimetric analysis (TGA) of the above sized fiber and sizing was conducted under air atmosphere. The heat degradation onset temperature of the sized fiber was 558 degrees Celsius as shown in FIG. 3. The heat degradation onset temperature of the sizing was 548 degrees Celsius and the 30% weight reduction temperature is 540 degrees Celsius as shown in FIG. 4, confirming the heat resistance is in excess of 500 degrees Celsius.

### Example 2

### Comparative Example 2

Polyamide66 resin impregnated tapes were fabricated by impregnating the same carbon fiber strands as Example 1 and Comparative Example 1 with polyamide66 resin at about 320 degrees Celsius according to a prior art, which included processes such as spreading strands, pre-heating, resin impregnation in a die, calendaring cooling and winding. The tape width was about 250 mm, the thickness was about 0.3 mm and the length was more than 1 meter. A tape made of carbon fiber with 0.16 weight % sizing could be fabricated successfully (Example 2), but another tape made of carbon fiber with 1.0 weight % sizing could not be done because of the high amount of sizing (Comparative Example 2).

### Example 3

### Comparative Example 3, 4

Test samples were prepared by stacking polyphenylenesulfide resin impregnated tapes of Example 1 (Examples 3), “Torayca” T700SC-12K-60E (Comparative Examples 3) and Unsized fiber T700SC-12K (Comparative Examples 4), melting, pressing and cooling in a mold.

In accordance with EN2850 Standard Test Method for “Compression Test Parallel to the Fibre Direction on Carbon Fibre Reinforced Plastics”, the compression tests were conducted. As a result, as indicated in Table 3, Example 3 is superior to Comparative Examples 3 and 4.

### Example 4

### Comparative Example 5, 6

Test samples were prepared by stacking polyamide66 resin impregnated tapes of Example 2 (Examples 4), “Torayca” T700SC-12K-60E (Comparative Examples 5) and Unsized fiber T700SC-12K (Comparative Examples 6), melting, pressing and cooling in a mold. Then test samples have been placed in deionised water at 80 degrees Celsius for 8 days to compare normal samples, which are not aged at all.

In accordance with EN2850 Standard Test Method for “Compression Test Parallel to the Fibre Direction on Carbon Fibre Reinforced Plastics”, the compression tests were conducted. As a result, as indicated in Table 4, the retained compressive strength in Example 4 is greater than 90%. On the other hand, Comparative Examples 5 and 6 are less than 90%.

### Example 5

### Comparative Example 7

SFFT was performed using the same carbon fiber as indicated in Example 1 (Example 5) and unsized fiber T700SC-12K (Comparative Example 7). Table 5 shows the IFSS result using polyetherimide resin matrix. It can be shown the IFSS of Example 5 is over 10% higher than that of Comparative Example 7.

While the invention has been explained with reference to the specific embodiments of the invention, the explanation is illustrative and the invention is limited only by the appended claims.

What is claimed is:

1. A thermoplastic resin impregnated tape having a carbon fiber, which is coated with a sizing at an amount X between 0.05 and 0.30 weight %, said sizing being formed of a heat resistant polymer or a precursor of the heat resistant polymer, said amount X being expressed with a following formula:
$$X = \frac{{W}_{0} - {W}_{1}}{{W}_{0}} \times 100$$
where W₀ is a weight of the carbon fiber with the sizing, and W₁ is a weight of the carbon fiber without the sizing.

2. The thermoplastic resin impregnated tape according to claim 1, wherein said heat resistant polymer on the carbon fiber has a thermal degradation onset temperature higher than 300 degrees Celsius.

3. The thermoplastic resin impregnated tape according to claim 1, wherein said heat resistant polymer on the carbon fiber has a thermal degradation onset temperature higher than 370 degrees Celsius.

4. The thermoplastic resin impregnated tape according to claim 1, wherein said heat resistant polymer on the carbon fiber has a thermal degradation onset temperature higher than 450 degrees Celsius.

5. The thermoplastic resin impregnated tape according to claim 1, wherein said heat resistant polymer on the carbon fiber has a 30% weight reduction temperature higher than 350 degrees Celsius.

6. The thermoplastic resin impregnated tape according to claim 1, wherein said heat resistant polymer on the carbon fiber has a 30% weight reduction temperature higher than 420 degrees Celsius.

7. The thermoplastic resin impregnated tape according to claim 1, wherein said heat resistant polymer on the carbon fiber has a 30% weight reduction temperature higher than 500 degrees Celsius.

8. The thermoplastic resin impregnated tape according to claim 1, which is made of a carbon fiber having an interfacial shear strength A greater than an interfacial shear strength B of the carbon fiber without the sizing to satisfy a relation of A>B, said interfacial shear strength A and B being measured with a single fiber fragmentation test.

9. The thermoplastic resin impregnated tape according to claim 8, which is made of a carbon fiber having the interfacial shear strength A satisfying a relation of A/B≧1.05.

10. The thermoplastic resin impregnated tape according to claim 8, which is made of a carbon fiber having the interfacial shear strength A satisfying a relation of A/B≧1.10.

11. A composite material comprising the thermoplastic resin impregnated tape according to claim 1, whose retained compression strength of the composite after wet aging is greater than 80%.

12. A composite material comprising the thermoplastic resin impregnated tape according to claim 1, whose retained compression strength of the composite after wet aging is greater than 90%.

13. The thermoplastic resin impregnated tape according to claim 1, wherein said heat resistant polymer or said precursor is applied to the carbon fiber in a form of an organic solution, an aqueous solution, an aqueous dispersion, or an aqueous emulsion.

14. The thermoplastic resin impregnated tape according to claim 1, which is made of a carbon fiber produced through a fabrication process including a carbonization process, a sizing application process, a drying process, and a continuous winding process.

15. The thermoplastic resin impregnated tape according to claim 1, which is made of a carbon fiber produced through a fabrication process including a drying process at a temperature higher 200 degrees Celsius for longer than 6 seconds.

16. The thermoplastic resin impregnated tape according to claim 1, which is made of a carbon fiber produced through a fabrication process including a drying process at a temperature higher 240 degrees Celsius for longer than 6 seconds.

17. The thermoplastic resin impregnated tape according to claim 1, which is made of a carbon fiber produced through a fabrication process including a drying process at a temperature higher 280 degrees Celsius for longer than 6 seconds.

18. The thermoplastic resin impregnated tape according to claim 1, wherein said heat resistant polymer on the carbon fiber includes at least one of a phenol resin, a melamine resin, a urea resin, a polyimide resin, a polyamideimide resin, a polyetherimide resin, a polysulfone resin, a polyethersulfone resin, a polyetheretherketone resin, a polyetherketoneketone resin, and a polyphenylenesulfide resin.

19. The thermoplastic resin impregnated tape according to claim 1, which is made of a carbon fiber having a tensile modulus between 200 and 600 GPa.

20. The thermoplastic resin impregnated tape according to claim 1, which is made of a carbon fiber having a tensile strength between 3.0 and 7.0 GPa.

21. The thermoplastic resin impregnated tape according to claim 1, which is made of a carbon fiber having a drape value less than 15 cm.

22. The thermoplastic resin impregnated tape according to claim 1, which is made of a carbon fiber being formed of filaments having a number between 1,000 and 48,000.
